(19) United States
(12) Patent Application Publication
(10) Pub. No.: US 2010/0059023 A1
(43) Pub. Date: Mar. 11, 2010

(54) Circuit Arrangement and Method for Operating an Inductive Load

(75) Inventors: Harald Schmauss, Donaustauf (DE); Walter Schrod, Regensburg (DE)

Correspondence Address: LERNER GREENBERG STEMER LLP, P O BOX 2480, HOLLYWOOD, FL, 33022-2480, US

(73) Assignee: CONTINENTAL AUTOMOTIVE GMBH, Hanover (DE)

(21) Appl. No.: 12/522,551

(22) PCT Filed: Jan. 2, 2008
(86) PCT No.: PCT/EP08/50009

§ 371 Date: Jul. 9, 2009

(30) Foreign Application Priority Data
Jan. 9, 2007 (DE) 10 2007 001 414.9

(51) Int. Cl. F02M 51/00; H01H 47/00

(52) U.S. Cl. 123/490; 361/152

(57) ABSTRACT

A circuit arrangement for operating at least one inductive load, for example a solenoid of a fuel injection valve, is configured to feed back electrical energy into a storage capacitor in a freewheeling phase after driving the load. In order to avoid an unwanted voltage increase on the capacitor, the circuit arrangement includes a DC/DC converter with the output-side storage capacitor to provide an operating voltage for the load. A drivable circuit arrangement optionally connects the load to the capacitor, and a freewheeling diode arrangement feeds back electrical energy into the capacitor after the circuit arrangement has been switched off. A protection circuit, which is connected in parallel with the capacitor, provides a current path for limiting the charging voltage on the capacitor in the event of an excessively high voltage on the capacitor.

The present invention relates to the operation of at least one inductive load.

In particular, the invention relates to an electronic driver circuit for operating solenoid injectors of a fuel injection system of an internal combustion engine. In such injectors, an injection valve is magnetically driven by means of a mostly cylindrical coil (solenoid). This drive concept is used both with normal-pressure and high-pressure systems. The invention further relates to an operating method for drive control of an inductive load such as for example a solenoid injector.

In the field of automotive electronics circuit arrangements for operating solenoid-actuated fuel injectors are known, in which a storage capacitor for supplying an operating voltage for the inductive load (for example solenoid) is provided in order during drive control of the solenoid to be easily able to supply a comparatively high electric current for a short time. The principle is further known, whereby after a disconnection of the solenoid a feedback of electrical energy into such a storage capacitor is provided in order to be able to utilize the feedback energy during the next solenoid drive control operation.

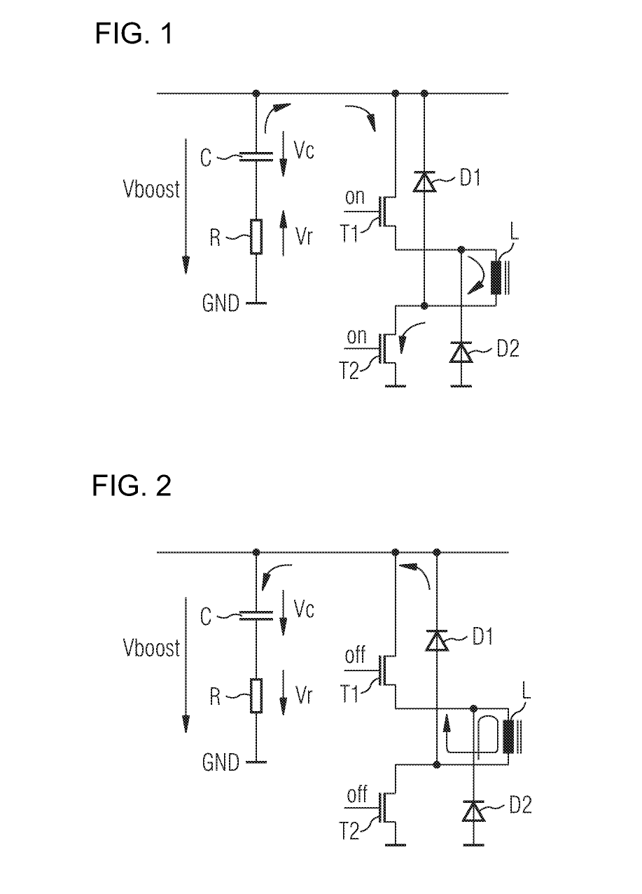

A problem that arises with this circuit concept will be explained using the example of a driver circuit that is based on internal operating knowledge of the applicant and is represented in FIGS. 1 and 2.

FIGS. 1 and 2 show a circuit part for operating an inductive load L, which may be for example the solenoid of a fuel injector of an internal combustion engine of a motor vehicle.

The circuit part comprises a storage capacitor C that is disposed at the output of a (non-illustrated) DC/DC converter for the purpose of providing an operating voltage Vboost for the inductive load L. A comparatively high voltage (boost voltage) is applied to the relevant injector in order to achieve the required opening current faster. To generate this voltage Vboost a step-up converter (DC/DC boost converter) for example is used, which steps up a vehicle battery voltage.

FIGS. 1 and 2 show, in series with the capacitor C, a resistor R that is not in fact inserted as a corresponding component into the circuit part but in practice has to be considered as “internal loss resistance” of the capacitor C for the function of the circuit part. This loss resistance R in the equivalent circuit diagram is often referred to as ESR “equivalent series resistance).

The circuit part further comprises a drivable switch arrangement, comprising two transistors T1 and T2, for the selective connection of the inductive load L to the storage capacitor C (and/or in practice to the series connection of a capacitor C and the internal loss resistance R).

As is represented in FIGS. 1 and 2, a first line path runs from a first connection of the capacitor (potential: Vboost) via the transistor T1 to a first connection of the load L. A second connection of the load L is connected by the transistor T2 to a second connection of the capacitor C that simultaneously represents the ground GND of the circuit part.

Finally, the circuit part comprises a free-wheeling diode arrangement comprising two free-wheeling diodes D1 and D2. The diode D1 connects the first connection of the capacitor C to the second connection of the load L. The diode D2 connects the first connection of the load L to the second connection (ground) of the capacitor C.

FIG. 1 illustrates the situation during driving of the load L by switching on the switch arrangement T1, T2 (the transistors T1 and T2 are switched on). As is represented by arrows in FIG. 1, in this situation a current flows from the first connection of the capacitor C via the components T1, L and T2 to ground GND. Because of the, in reality unavoidable, series resistance R the operating voltage Vboost available for driving the load L is reduced as a result of a voltage drop Vr at the resistor R relative to a voltage Vc at the capacitor C to a greater or lesser extent, dependent on the flowing current.

After a disconnection of the switch arrangement T1, T2 the operating phase illustrated in FIG. 2 arises, during which a feedback of electrical energy from the load L back into the storage capacitor C occurs.

As is represented by arrows in FIG. 2, in this operating phase a current flows from the second connection of the load L via the first free-wheeling diode D1 to the first connection of the capacitor C and a current flows from the second connection of the capacitor C (via the resistor R) via the second free-wheeling diode D2 to the first connection of the load L.

The topology of the illustrated circuit part therefore enables a free-wheeling current that flows through the two free-wheeling diodes D1 and D2 and during this free-wheeling phase feeds energy stored in the magnetic field of the inductive load L back into the storage capacitor C. Because of the inherent resistance R this feedback current gives rise to a voltage drop Vr at the resistor R that is added as additional voltage to the boost voltage Vboost.

This voltage overshoot and/or the additional voltage drop via the internal resistance R generally becomes greater with ageing of the capacitor and at low temperatures since in both cases the resistance R increases.

Particularly if the operating voltage Vboost provided by the DC/DC converter for the storage capacitor C is used moreover as a supply voltage for at least one further electronic circuit and/or electronic component of the vehicle electronics, this further electronic circuit and/or component thereof has to be so dimensioned that the described voltage overshoot does not exceed its maximum supply voltage. Otherwise such components may be damaged or even destroyed.

The problem could be aggravated by the use of a capacitor C with a particularly low internal resistance R. Such capacitors are namely available, for example in the form of ceramic capacitors or membrane capacitors. The drawback is however that these capacitors are obtainable only with relatively low capacitance values and/or in large styles of construction. Low capacitance values are disadvantageously able to take up only a small portion of the available feedback energy and reduce the voltage overshoot only to a limited extent.

It is an object of the present invention to provide a circuit arrangement and a method for operating at least one inductive load, by means of which the previously described drawbacks may be avoided and in particular an undesirable voltage overshoot during the free-wheeling phase may be reduced.

This object is achieved according to the invention by a circuit arrangement according to claim 1 and by an operating method according to claim 8.

In the circuit arrangement according to the invention a protective circuit disposed parallel to the storage capacitor is provided, which in the event of an excessively high voltage at the storage capacitor provides a current path (parallel to the storage capacitor).

This current path may advantageously have the effect of limiting the feedback current into the storage capacitor or even act as a “discharge passage” for partially discharging the storage capacitor.

With such a protective circuit it is easily possible to remove some of the feedback current to the ground of the circuit arrangement and hence avoid an excessive voltage drop via the internal resistance R that is the cause of the rise of the boost voltage.

The inductive load may be in particular a solenoid, in particular a solenoid for actuating a fuel injection valve of an internal combustion engine.

In an embodiment it is provided that the operating voltage provided at the storage capacitor is further provided as a supply voltage or a signal voltage of at least one further electronic circuit. Such a signal voltage may be for example a voltage having an amplitude that is dependent on the operating voltage. The further electronic circuit may be for example a driver chip for a solenoid injection driver.

In an embodiment the DC/DC converter takes the form of a step-up converter. In the field of automotive electronics it is therefore possible to convert for example a battery voltage (for example 12 V) to a higher operating voltage (Vboost) that is suitable in particular for the drive control of solenoid-actuated injection valves.

In a preferred embodiment the storage capacitor takes the form of an electrolytic capacitor. With electrolytic capacitors relatively high capacitance values may be achieved advantageously in an installation space-saving manner. The relatively high internal resistance with this type of capacitor plays a subordinate role in the configuration according to the invention as the limiting of the feedback current into the capacitor that is optionally provided according to the invention and/or the partial discharge of the capacitor reliably prevents an otherwise to-be-feared voltage overshoot.

Naturally, the storage capacitor may alternatively be formed by a parallel arrangement of a plurality of single capacitors.

In an embodiment it is provided that the DC/DC converter supplies the operating voltage at a nominal voltage value that is higher than a voltage value that is theoretically sufficient for drive control of the inductive last. The “theoretically sufficient” voltage value in the case of a solenoid for actuating a magnetic valve is for example the voltage value, at which the relevant valve positioning operation (for example valve opening operation) is already achievable.

In an embodiment it is provided that the switch arrangement comprises a first switch for connecting a first connection of the storage capacitor to a first connection of the inductive load as well as a second switch for connecting a second connection of the storage capacitor to a second connection of the inductive load.

The free-wheeling diode arrangement preferably comprises a first diode in a path from the second connection of the inductive load to the first connection of the storage capacitor as well as a second diode in a path from the first connection of the inductive load to the second connection of the storage capacitor, it being possible for one of the two connections of the storage capacitor to be connected for example permanently to ground of the circuit arrangement.

In a development of the invention it is provided that in the event of an excessively high voltage at the storage capacitor this voltage is limited or reduced in the manner of a closed-loop control operation to a defined setpoint value.

For this purpose, in an—in circuit engineering terms—simple manner for example on the basis of the operating voltage a reference voltage that is characteristic of the mean operating voltage over time may be derived, which is compared with a threshold value (setpoint value) in order to activate the current path and/or the discharge passage in the event of a corresponding voltage overshoot.

Taking the mean over time has the advantage that voltage dips of the operating voltage, which are caused by a removal of energy during the switch-on phase, have hardly any effect or at most a slight effect upon the reference voltage. Such a reference voltage may be derived for example via a network of resistors and capacitors from the operating voltage.

The corresponding “time constant” of taking the mean over time may in this case be so dimensioned that the reference voltage may follow control actions upon the DC/DC converter for intentional variation of the operating voltage.

The feedback current limitation and/or partial discharge of the storage capacitor that is optionally to be provided may then be realized on the basis of a comparison of the reference voltage with a for example permanently defined threshold voltage: a relatively high voltage at the capacitor (detected by means of a comparison of the reference voltage with the threshold voltage) switches on the current path of the protective circuit and/or increases the current flowing through the current path, whereas a relatively low voltage at the capacitor (detected by means of a comparison of the reference voltage with the threshold voltage) disconnects and/or reduces the current carried through the current path.

One advantage of the invention is that the optionally occurring limitation of the storage capacitor charging current and/or partial discharge of the storage capacitor and hence limitation and/or reduction of the operating voltage may of course be activated if the operating voltage reaches a nominal value and/or rises above this nominal value. If the operating voltage remains in a nominally permissible range, then the corresponding protective circuit may remain inactive.

There now follows a further description of an embodiment of the invention with reference to the accompanying drawings. The drawings show:

FIG. 1 a circuit part of a solenoid driver circuit, represented for an energizing phase,

FIG. 2 the circuit part of FIG. 1, but represented for a free-wheeling phase,

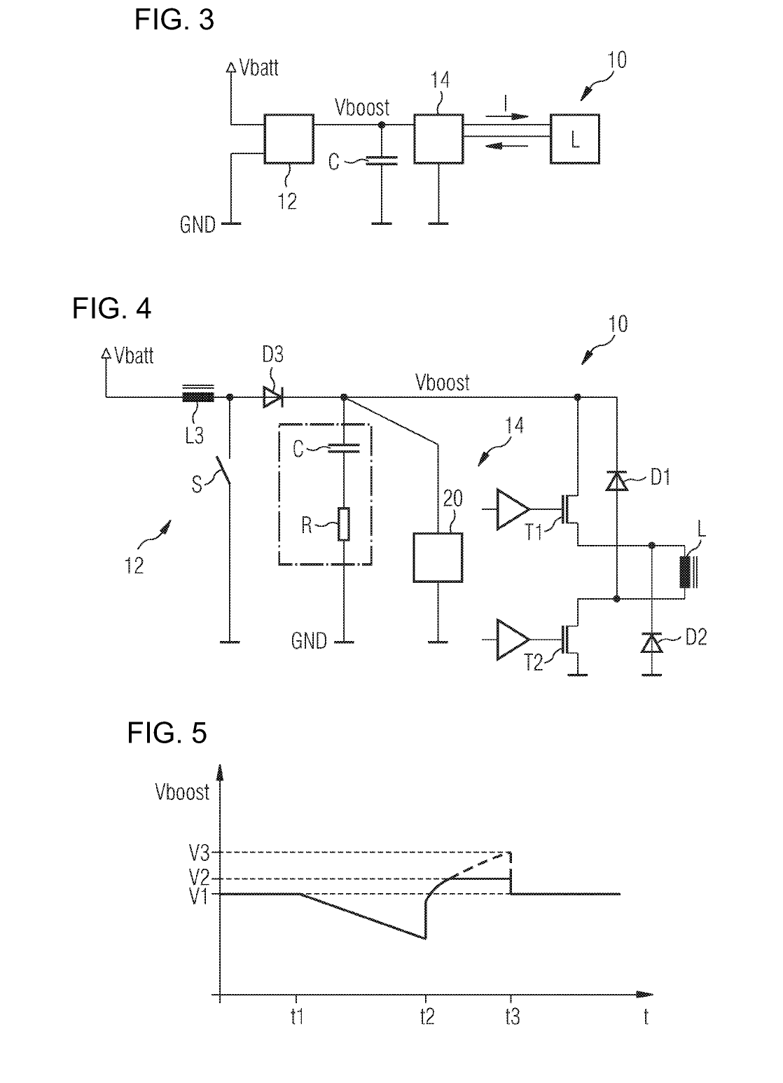

FIG. 3 a block diagram of a circuit arrangement for operating an inductive load,

FIG. 4 a more detailed representation of the circuit arrangement of FIG. 3, and

FIG. 5 a representation of the time characteristic of an operating voltage present in the region of the circuit arrangement of FIG. 4, represented for the situations with and without a protective circuit.

FIG. 3 shows an embodiment of a circuit arrangement 10 for operating an inductive load L (here: solenoid of a fuel injector).

The circuit arrangement 10 comprises a DC/DC converter 12 with an output-side storage capacitor C for providing an operating voltage Vboost (nominal output voltage of the converter 12 in the form of a step-up converter). The input-side supply of the converter 12 is effected by applying an input operating voltage Vbatt (in relation to ground GND).

The circuit arrangement 10 further comprises a drivable switch arrangement 14 for selectively connecting the inductive load to the storage capacitor C. In a switched-on state of the switch arrangement 14, the operating voltage Vboost provided at the storage capacitor C is applied to the inductive load L. During this driving phase a current I, which is represented by arrows in FIG. 3, flows through the inductive load L.

FIG. 4 shows the circuit arrangement 10 in more detail. It is evident from this that the DC/DC converter 12 in an as such known manner may take the form of a step-up converter, in which a reactor L3 is connected in series to a converter free-wheeling diode D3, which is followed by the storage capacitor C. By means of clocked drive control (switching on and off) of a switch S implemented for example as a transistor a circuit node that connects the components L3 and D3 is repeatedly connected to ground GND and disconnected again therefrom. This leads in an as such known manner to charging of the capacitor C to a charging voltage that is higher than the supplied supply voltage Vbatt.

The representation of FIG. 4 shows in the sense of an equivalent electrical block diagram (dashed line) the capacitor C together with the, in practice unavoidable, internal resistance R thereof.

The layout and function of the switch arrangement 14 represented in FIG. 4 correspond to the layout and function of the arrangement already described in the introductory part with reference to FIGS. 1 and 2.

A characteristic feature of the circuit arrangement 10 represented in FIG. 4 is however that a protective circuit 20 (for example in the form of part of the switch arrangement 14 represented as a block in FIG. 3) disposed parallel to the storage capacitor C is provided, which in the event of an excessively high voltage at the storage capacitor C (and/or more precisely at the series connection of capacitor C and internal resistance R) provides a current path parallel to the storage capacitor C.

Thus, in a simple and reliable manner during the operating phase, in which a free-wheeling current for charging the storage capacitor C is fed back via the free-wheeling diodes D1 and D2, the capacitor charging current is limited and hence an undesirably high voltage overshoot at the capacitor C is avoided.

For the concrete realization of the protective circuit in terms of circuit engineering, diverse options are available to the person skilled in the art. In the illustrated embodiment the protective circuit 20 functions for example in such a way that, in the event of a permanently defined voltage threshold being exceeded by the operating voltage Vboost, a current path is formed between the, in FIG. 4 top, capacitor connection and ground GND and is maintained until the operating voltage Vboost drops back down below this threshold voltage (or a second permanently defined threshold voltage).

FIG. 5 shows by way of example a characteristic of the operating voltage Vboost as a function of time t.

The DC/DC converter 12 sets the operating voltage Vboost nominally to a voltage value V1. At a time t1 the switch arrangement 14 (transistors T1 and T2 in FIG. 4) is switched on and at a time t2 switched off again. In the period between t1 and t2, the high removal of current from the capacitor C leads to a dropping of the voltage Vboost. Because of the feedback, however, the disconnection at the time t2 is followed by a very rapid rise of the operating voltage Vboost that leads to a voltage overshoot (beyond V1).

However, as soon as the protective circuit 20 detects that the operating voltage Vboost has reached a threshold voltage V2 lying above the voltage V1, the protective circuit 20 provides a discharge passage that carries current away to the vehicle ground GND. Thus, in the manner of a closed-loop control operation a rise beyond the threshold voltage V2 is prevented until the feedback current at a time t3 at any rate comes to a halt and the operating voltage Vboost drops back down to the level V1.

For the purpose of comparison, FIG. 5 shows by means of dashes a characteristic of the operating voltage Vboost that would arise without the protective circuit 20. From this it is evident that without the protective circuit 20 in the period between t2 and t3 a far greater voltage overshoot, namely up to a voltage value V3, would occur.

The voltage limitation characteristic represented by way of example in FIG. 5 may be achieved in terms of circuit engineering in a particularly simple manner for example by disposing a transistor in the protective circuit 20 in such a way that it may carry current away from Vboost to GND. The drive control operation (for example determined by a gate potential in an FET) may be effected by means of a reference voltage, which is derived from the operating voltage Vboost via a resistor-capacitor network and is characteristic of a mean operating voltage Vboost over time. If the transistor for example in the form of a P-channel FET possesses a fixed threshold voltage (gate source voltage), at which it becomes conductive, then the transistor behaves like a closed-loop controller that carries away so much current to GND that Vboost is reduced to a predetermined voltage level and/or is maintained at this voltage level.

1-8. (canceled)

9. A circuit arrangement for operating at least one inductive load, comprising:
a DC/DC converter with an output-side storage capacitor for providing an operating voltage for the inductive load;
a drivable switch arrangement for selectively connecting the inductive load to said storage capacitor;
a free-wheeling diode arrangement for feeding back electrical energy into said storage capacitor after a disconnection of said switch arrangement; and
a protective circuit connected in parallel with said storage capacitor and configured to provide a current path on occasion of an excessively high voltage at said storage capacitor.

10. The circuit arrangement according to claim 9, wherein the inductive load is a solenoid of a fuel injection valve of an internal combustion engine.

11. The circuit arrangement according to claim 9, wherein the operating voltage provided at said storage capacitor is also a supply voltage or a signal voltage for at least one further electronic circuit.

12. The circuit arrangement according to claim 9, wherein said DC/DC converter is a step-up converter.

13. The circuit arrangement according to claim 9, wherein said storage capacitor is an electrolytic capacitor.

14. The circuit arrangement according to claim 9, wherein said DC/DC converter is configured to supply the operating voltage at a nominal voltage value that is higher than a voltage value that is theoretically sufficient for driving the inductive load.

15. The circuit arrangement according to claim 9, wherein said switch arrangement comprises a first switch for connecting a first connection of said storage capacitor to a first connection of the inductive load and a second switch for connecting a second connection of said storage capacitor to a second connection of the inductive load.

16. The circuit arrangement according to claim 9, wherein said protective circuit, in the event of an excessively high voltage at said storage capacitor, limits or reduces the voltage in a closed-loop control operation to a defined setpoint value.

17. A method of driving at least one inductive load, the method which comprises:
converting a DC voltage to a DC voltage and providing an operating voltage for the inductive load at a storage capacitor;
selectively connecting the inductive load to the storage capacitor;
upon disconnecting the inductive load from the storage capacitor, feeding back electrical energy into the storage capacitor; and
in an event of an excessively high voltage at the storage capacitor, providing a current path parallel to the storage capacitor.

18. The method according to claim 17, which comprises connecting a solenoid of a fuel injection valve of an internal combustion engine and driving the solenoid.
